(19) United States
(12) Patent Application Publication
(10) Pub. No.: US 2026/0073659 A1
(43) Pub. Date: Mar. 12, 2026

(54) SYSTEM AND METHOD FOR DETECTING HAZARDOUS VEHICLES USING ROADSIDE CAMERAS

(71) Applicant: VALERANN LTD., Tel Aviv (IL)

(72) Inventors: TOM LADYMAN, London (GB); Ido GLANZ, Tel Aviv (IL); Kelvin TSZ HEI CHOI, London (GB); Ran KATZIR, London (GB)

(73) Assignee: VALERANN LTD., Tel Aviv (IL)

(21) Appl. No.: 19/393,740

(22) Filed: Nov. 19, 2025

Related U.S. Application Data
(63) Continuation of application No. PCT/IL2024/050481, filed on May 16, 2024.
(60) Provisional application No. 63/503,502, filed on May 22, 2023.

(51) Int. Cl. G06V 10/36; G06T 3/40; G06V 10/25; G06V 10/28; G06V 20/40; G06V 20/54

(52) U.S. Cl. CPC G06V 10/36; G06T 3/40; G06V 10/25; G06V 10/28; G06V 20/44; G06V 20/54; G06V 2201/08

(57) ABSTRACT

A system and method for detecting hazard lights of vehicles in a video stream including: spatially downsampling a plurality of sequential frames from the video stream to obtain a plurality of down-sampled pixels in each of the frames; and repeating for one or more of the plurality of down-sampled pixels: generating a time series for the down-sampled pixel by ordering values of the down-sampled pixel from the plurality of sequential frames over time; converting the time series into the frequency domain to obtain a frequency domain representation of the time series; and determining that hazard lights are present in the down-sampled pixel based on the frequency domain representation.

### CROSS-REFERENCE TO RELATED APPLICATIONS

This application is a continuation of PCT International Application No. PCT/IL2024/050481, International Filing Date May 16, 2024, published as WO2024/241307 entitled System and Method for Detecting Hazardous Vehicles Using Roadside Cameras and claiming the benefit of U.S. Provisional Ser. No. 63/503,502 filed May 22, 2023, all of which being incorporated by reference herein.

### FIELD OF THE INVENTION

The present invention relates generally to analysis of road related data, and more specifically, to detecting hazardous vehicles by analyzing video capturing road related data in the frequency domain.

### BACKGROUND OF THE INVENTION

Stopped vehicle detection (SVD) may refer to various technologies implemented by a traffic management center (TMC) to detect a stopped or stationary vehicle. SVD may improve overall road safety and traffic efficiency by enabling a control room operator of the TMC to respond quickly and manage the situation. For example, the control room operator may set warning signs to users on the road, close one or more lanes, adjust speed limits, deploy traffic officers, call for emergency interventions, etc. Thus, SVD may enable timely response and intervention in SVD situations, and may prevent or reduce adverse effects caused by the stationary vehicle such as potential traffic congestion or accidents.

### SUMMARY OF THE INVENTION

A computer-based system and method for detecting hazard lights of vehicles may include: spatially downsampling a plurality of sequential frames from the video stream to obtain a plurality of down-sampled pixels in each of the frames; and repeating for one or more of the plurality of down-sampled pixels: generating a time series for the down-sampled pixel by ordering values of the down-sampled pixel from the plurality of sequential frames over time; converting the time series into the frequency domain to obtain a frequency domain representation of the time series; and determining that hazard lights are present in the down-sampled pixel based on the frequency domain representation.

According to embodiments of the invention, determining that the hazard lights are present in the down-sampled pixel may include applying a band pass filter to the frequency domain representation to obtain a filtered signal.

According to embodiments of the invention, determining that the hazard lights are present in the down-sampled pixel may include: detecting peaks in an amplitude of the filtered signal; and detecting the hazard lights if a detected peak satisfies a threshold.

Embodiments of the invention may include: comparing a phase of the filtered signal with a phase of a filtered signal of a neighbour down-sampled pixel; and determining that the filtered signal and the filtered signal of a neighbour down-sampled pixel originate from a single source if the phase of the filtered signal equals the phase of the filtered signal of a neighbour down-sampled pixel and that the filtered signal and the filtered signal of a neighbour down-sampled pixel originate from two sources.

According to embodiments of the invention, determining that the hazard lights are present in the down-sampled pixel may be performed further based on heuristics of the frequency domain signal.

Embodiments of the invention may include: converting the frame into grayscale.

According to embodiments of the invention, spatially downsampling a frame of the plurality of sequential frames may include: dividing the frame into smaller grid boxes; and calculating a measures of center of the grayscale values in each grid box.

Embodiments of the invention may include: presenting the location of the detected hazard lights to a user.

Embodiments of the invention may include: obtaining a definition of a region of interest from a user; and presenting the location of the detected hazard lights that are within the region of interest to the user.

Embodiments of the invention may include: detecting a change in pan, tilt and zoom (PTZ) values of a camera providing the video stream; and adjusting the region of interest and the downsampling to the new PTZ values.

Embodiments of the invention may include: unifying the hazard lights event with other event sources and context such as in-car hazard light information, traffic metrics, weather, geography, and accident risk to prioritise the event.

### BRIEF DESCRIPTION OF THE DRAWINGS

Non-limiting examples of embodiments of the disclosure are described below with reference to figures listed below. The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanying drawings.

FIG. 1 schematically illustrates a system for detecting hazard lights of vehicles, according to some embodiments of the invention.

FIG. 2 depicts a frame divided into smaller grid boxes, according to some embodiments of the invention.

FIG. 3 depicts the mean of the values in each grid box in the frame of FIG. 2, according to some embodiments of the invention.

FIG. 4 depicts a down-sampled frame, according to some embodiments of the invention.

FIG. 5 depicts the amplitude and phase of a first down-sampled pixel from FIG. 4, according to some embodiments of the invention.

FIG. 6 depicts the amplitude and phase of a second down-sampled pixel from FIG. 4, according to some embodiments of the invention.

FIG. 7 shows a flowchart of a method for detecting hazard lights of vehicles, according to some embodiments of the invention.

FIG. 8 shows a high-level block diagram of an exemplary computing device, according to some embodiments of the invention.

It will be appreciated that, for simplicity and clarity of illustration, elements shown in the figures have not necessarily been drawn accurately or to scale. For example, the dimensions of some of the elements may be exaggerated relative to other elements for clarity, or several physical components may be included in one functional block or element. Reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

Highway control centers or TMCs are responsible for monitoring multiple systems and data sources simultaneously. These systems generate alerts that should be addressed quickly to ensure the safety of road users. One of those alerts is SVD. An SVD situation may be significant since a stopped vehicle may be a result of a car crash that may require immediate interventions and can cause congestion in the road. SVD may include identifying and locating stopped or stationary vehicles in an image or video stream of a road, or of the part of the road in which vehicles are supposed to be moving (e.g., stopped vehicle in a parking spot or in a red light should not ignite an SVD alert).

Conventional solutions for detecting SVDs may include detecting vehicles and tracking their motion through road cameras. For example, vehicles may be detected using a neural network (NN) that is trained for that purpose, such as you only look once (YOLO) which is a NN based real-time object detection system. Tracking, e.g., following the movement of the detected vehicle, may be achieved using an online tracker such as simple online and real-time tracking (SORT) algorithm or deep SORT. YOLO may predict bounding boxes and class probabilities, e.g., if a probability of a bounding box to be a vehicle is estimated by YOLO to be above a threshold, the system may determine that the bounding box includes a vehicle. SORT algorithm may track multiple detected vehicles simultaneously by associating detections across frames of the video stream. The combination of detection and tracking may identify stopped vehicles by looking for vehicles with zero speed, in regions of interest (ROI), e.g., in locations and times in which vehicles should be moving, and may identify car accidents by looking for unusual motion.

However, conventional SVD alert systems are often prone to error. For example, poor lightning conditions may cause cameras to not detect vehicles at night effectively. Similarly, glare and fog may reduce the effectiveness of detection. In addition, detecting and tracking a stopped vehicle in a video stream may not be efficient in complex environments where the vehicle may be occluded by other objects or where the appearance of the vehicle may change by different factors such as lighting changes. Detection may give poor results in cases where the camera viewpoint with relation to the stopped vehicle is not ideal. When detection is poor, tracking is poor, and inaccuracy is propagated. Without ideal conditions, the detected speed, direction and behavior of vehicles may become very inaccurate. In addition, NN-based SVD systems for detecting accidents or car crashes may be problematic since there is a very limited positive data set of accidents, which are by nature a very unconstrained event, so it is difficult to train, validate and test the NN based detection tools for detecting car accidents. Another problem is that detecting and tracking tools cannot handle un-cooperative movement of cameras, e.g., independent pan, tilt, zoom (PTZ) movement of the camera that are very common for road cameras.

There are non-camera solutions which aim to reduce the effect of visibility and night-time issues, e.g. radar and Lidar, but these still require a full knowledge of vehicle behaviors, e.g., to classify an accident, and require specialist and expensive hardware.

In-car solutions that exist for SVD may detect accidents and breakdowns using car sensors and output via e.g. cellular network. These solutions may require collaboration with manufacturers and service suppliers and therefore their efficiency may depend on wide adoption of specific technology in vehicles, e.g., vehicles that do not include this technology or that are for some reason not connected will not be detected.

Vehicle hazard lights may include lights on the front and/or rear that flash on and off, typically at frequencies of 1Hz-2Hz. Drivers are advised to operate hazard lights when their vehicle is stationary to warn other road users that the vehicle may be causing a temporary traffic obstruction. In some vehicles, hazard lights may be operated automatically following a car crash or accident. According to embodiments of the invention, detecting hazard lights, e.g., detecting that the hazard lights are turned on and blinking, may be used for detecting stopped vehicles and accidents, as a stand-alone method, or combined with other SVD methods.

Naive methods for detecting flashing hazard lights typically start with a feature extraction phase e.g. masking out hazard lights of a car. This feature is then filtered using temporal methods. However, these methods, while rather expensive, do not provide sufficient accuracy. These algorithms are not robust to camera quality and do not perform well if the source of the hazard lights is occluded. In addition, the feature detection stage does not work well at night.

Embodiments of the invention may provide a system and method for detecting hazard lights that is efficient and accurate, e.g., even under poor lightning conditions, and uses relatively low computational power. Embodiments of the invention may detect hazard lights of vehicles in a video stream by spatially downsampling sequential frames from the video stream, generating a time series for the down sampled pixels by ordering values of the down-sampled pixels from the plurality of sequential frames over time, converting the time series to the frequency domain, and determining that hazard lights are present in the down-sampled pixel by analysing the the frequency domain representation, e.g., by analysing the amplitude and/or phase of the frequency domain representation. Since the frequency or ranges of frequencies of hazard lights is known, it is possible to search for those frequencies in the down-sampled signal, e.g., by using a bandpass filter with a pass band at the known frequencies, e.g., 1 Hz-2 Hz, and detecting peaks in the filtered signal. Phase data may also be used. In some embodiments, the phase data may be used for denoising, e.g., to check whether multiple regions are flashing synchronously, which may indicate that those regions originated from the same source, e.g., illuminated by the same light source or include two headlights of the same vehicle. For example, if a phase of two down-sampled pixels that include hazard lights is aligned, it may be determined that both represent hazard lights from the same source. However, if the phase is not aligned, it may be determined that each represent hazard lights from a different source. As used herein a light source or a source may refer to physical light-emitting device, e.g., a light source of a vehicle.

Once hazard lights are detected, the location of the hazard lights may be presented to a user, e.g., a control center operator. The detection of hazard lights may be augmented, unified or fused with other event source data and context data such as traffic metrics, weather, geography, and accident risk to prioritise the event. Embodiments of the invention may be particularly useful for transport operation centers that need to respond quickly to SVD events.

Thus, embodiments of the invention may improve the technology of SVD and hazard lights detection for transport operation centers by providing more accurate results with lower computational power compared to conventional methods. Specifically, downsampling and converting the time series of the down-sampled pixels into the frequency domain requires less computational power compared to detecting and tracking objects or to feature extraction in images of a video stream. In addition, analyzing the frequency domain signal for detecting hazard lights provides accurate results, even in cases of occlusions and poor lighting conditions.

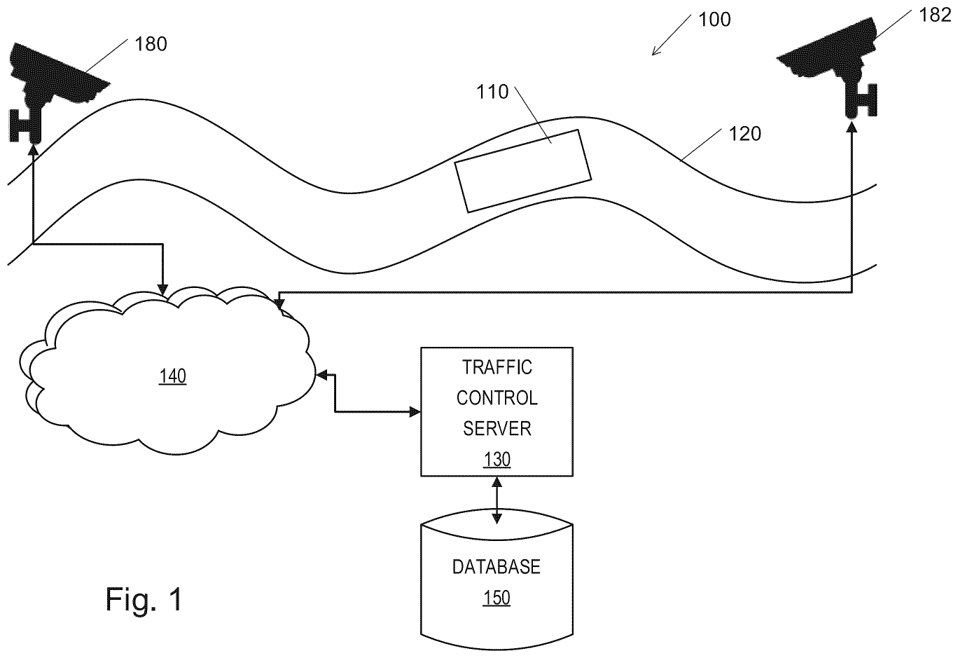

Reference is now made to FIG. 1, which schematically illustrates a system 100 for detecting hazard lights of vehicles 110, according to some embodiments of the invention. According to one embodiment of the invention, system 100 may include traffic cameras 180 and 182 that are connected to traffic control server 130, e.g., of a traffic control centre or TMC, over networks 140. Traffic cameras 180 and 182 may capture images of a real-world road, way, path or route 120. A vehicle 110 moving along road 120, or stopped along road 120, may be captured by one or both traffic cameras 180 and 182, depending on the location of vehicle 110 in relation to the field of view (FOV) of cameras 180 and 182. Traffic cameras 180 and 182 may provide a video stream including the captured images to traffic control server 130 over networks 140. While only two traffic cameras 180 and 182 are depicted in FIG. 1, this is for demonstration purposes only, and system 100 may support any number of, e.g. tens, hundreds or more, traffic cameras.

Each of traffic cameras 180 and 182 may be a static camera, a PTZ camera, a CCTV camera, an ANPR camera, an IP camera, a panoramic camera, a thermal camera, etc. Each of traffic cameras 180 and 182 may be positioned to capture images of road 120. Some of traffic cameras 180 and 182 may be controlled to change their FOV, e.g., using the tilt, pan and/or zoom functionalities that some of those cameras may include. Each of traffic cameras 180 and 182 may include a wired or wireless network interface for connecting to network 140.

Network 140 may include any type of network or combination of networks available for supporting communication between traffic cameras 180 and 182 and traffic control server 130. Network 140 may include, for example, a wired, wireless, fiber optic, cellular, satellite or any other type of connection, a local area network (LAN), a wide area network (WAN), the Internet and intranet networks, etc.

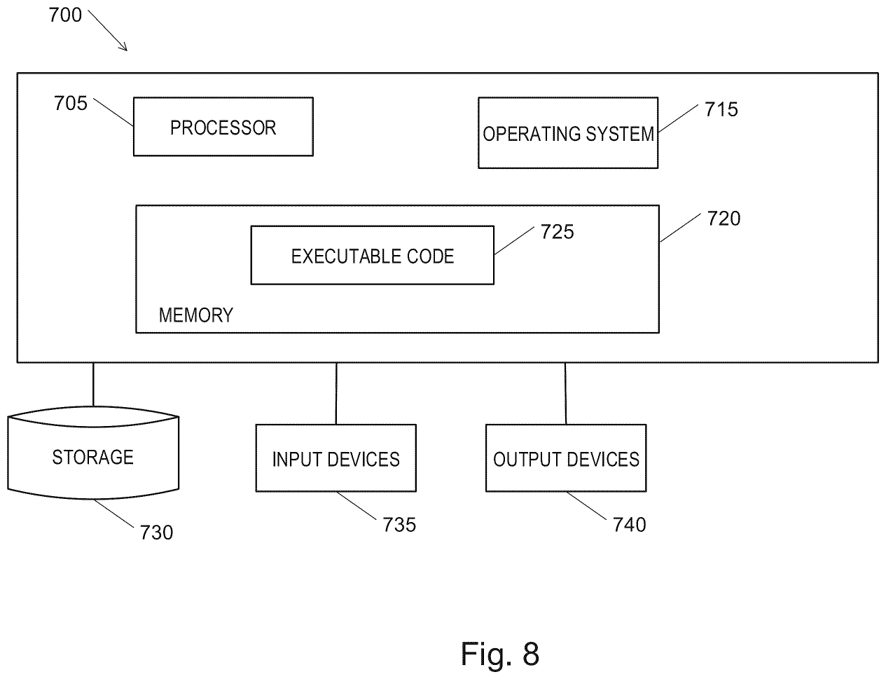

Each of traffic control server 130 and traffic cameras 180 and 182 may be or may include a computing device, such as computing device 700 depicted in FIG. 8. One or more databases 150 may be or may include a storage device, such as storage device 730. Traffic control server 130 and database 150 may communicate directly or over networks 140. In some embodiments, traffic control server 130 and database 150 may be implemented in a remote location, e.g., in a ‘cloud’ computing system.

According to some embodiments of the invention, traffic control server 130 may store in database 150 data obtained from traffic cameras 180 and 182 and other data, such as mapping and models of road 120 and surrounding area, algorithm parameters, and any other data as required by the application. According to some embodiments of the invention, traffic control server 130 may be configured to obtain video streams of road 120 captured by traffic cameras 180 and 182, and to detect hazard lights within these video streams.

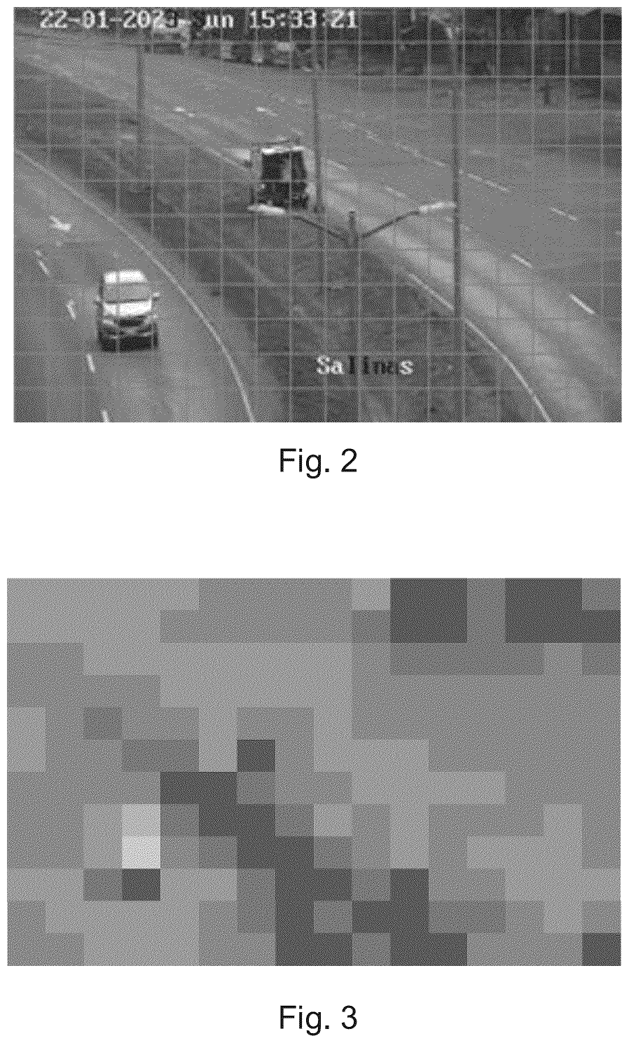

For example, traffic control server 130 may analyse batches of sequential frames, e.g., frames in the video stream that are ordered in time, such as consecutive frames or frames sampled in constant intervals from a video stream, etc. In some applications, a definition of a region of interest (ROI) may be obtained from the user, and only the ROI may be analysed for detecting hazard lights. Traffic control server 130 may spatially downsample each of the analysed frames to obtain a plurality of downsampled pixels in each of the frames. It is noted that downsampling is performed in order to reduce noise and may be avoided if the spatial resolution of traffic camera 180 is low enough. The frames may be downsampled to a frame of 20*20 pixels. Down sampling may be performed in any applicable manner. For example, downsampling may include dividing an original image frame into smaller grid boxes, e.g., as presented in FIG. 2, and calculating a measures of center, e.g., mean, median, mode, etc., of the values in each grid box. FIG. 3 depicts the frame of FIG. 2 in which a mean (average) of the values is calculated in each grid box.

In some embodiments of the invention, analysed frames may be converted to greyscale prior to (or subsequent to) downsampling. In some embodiments the colour or components of the image may be analysed depending to the colour model of the image. For example, for RBG images each of the R, G and B values may be analysed as disclosed herein, or the V component may be analysed in hue, saturation, value (HSV) images, etc.

Some embodiments of the invention may determine whether hazard lights are present in the down-sampled pixel by analysing the frequency domain representation of the pixel. This may be achieved by generating a time series for one or more pixels in the sequential frames, e.g., by ordering values of the down-sampled pixel from the plurality of sequential frames over time, and converting the time series into the frequency domain, e.g., using fast Fourier transform (FFT) or any other applicable transformation into the frequency domain, to obtain frequency domain representation. Both the amplitude and phase of the frequency domain may be used for detecting hazard lights, as well as heuristic data from the image or time domain signal. For example, detecting hazard lights in a down-sampled pixel may include applying a band pass filter to the frequency domain representation, detecting peaks in an amplitude of the filtered signal, and determining that the down-sampled pixel includes hazard lights if a detected peak satisfies a threshold.

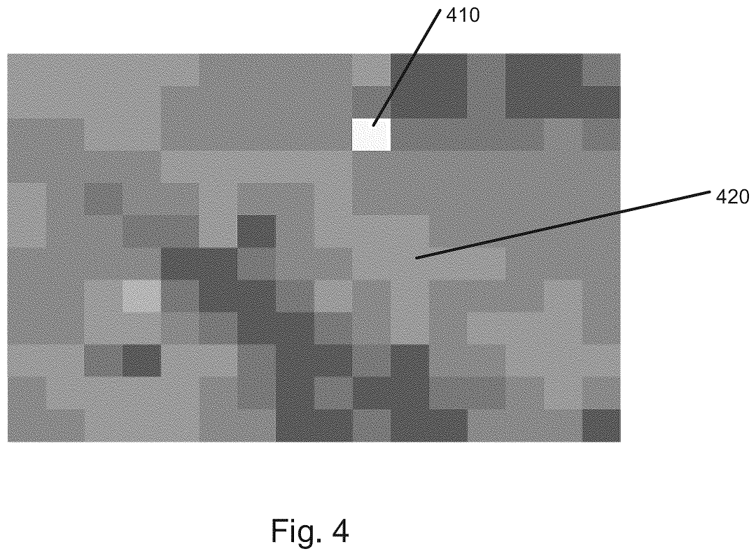

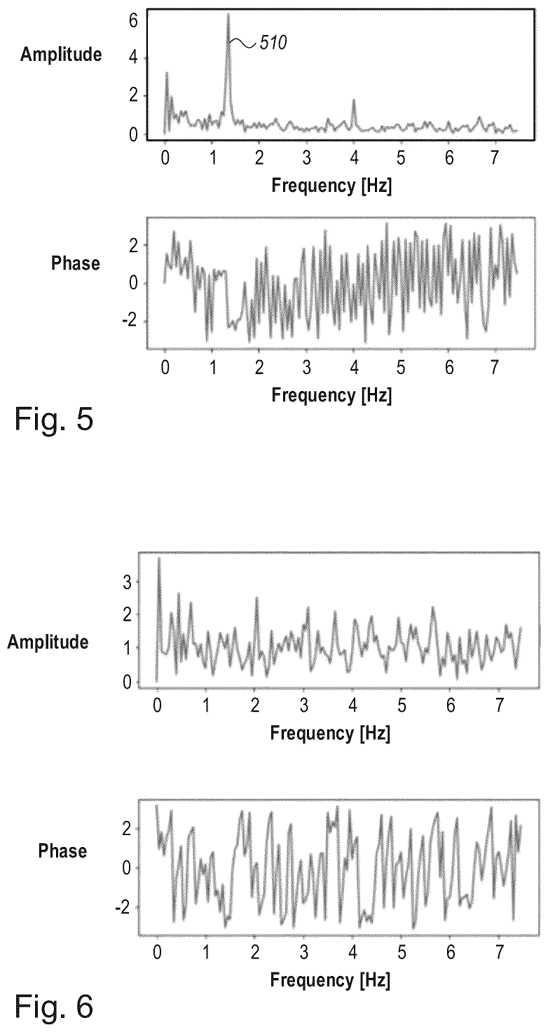

Examples of the amplitude and phase of a filtered frequency domain representation of two down-sampled pixels 410 and 420 from a single image 400 presented in FIG. 4 are presented in FIGS. 5 and 6. FIG. 5 depicts the amplitude and phase of down-sampled pixel 410, and FIG. 6 depicts the amplitude and phase of down-sampled pixel 420. As can be seen in FIG. 5 there is a distinct peak 510 at frequency 1.3 Hz and such a peak does not exist in the amplitude of down-sampled pixel 420 depicted in FIG. 6. Thus, it may be assumed that down-sampled pixel 410 includes hazard lights and down-sampled pixel 420 does not include hazard lights.

According to some embodiments, the phase of the filtered frequency domain representation may be analysed as well, e.g., for denoising. For example, if two neighboring down-sampled pixels are found to include hazard lights, the phase of the filtered frequency domain representation of the two signals may be compared. It may be assumed that the two down-sampled pixel include hazard lights that originate from a single source, e.g., illuminated by or originate from the same vehicle, if both the phase of the filtered signal of the down-sampled pixel and the phase of the filtered signal of the neighbor down-sampled pixel are aligned or synchronous, and that the two down-sampled pixels include hazard lights that originate from different sources, e.g., from two vehicles, if the phase of the filtered signal of the down-sampled pixel and the phase of the filtered signal of the neighbor down-sampled pixel are not aligned or synchronous. For example, alignment may be estimated or measured by comparing the phase signals or peaks of each of the phase signals e.g., the biggest three peaks, and see if they correlated within a range, e.g., 3-7% of each other.

The location of the detected hazard lights may be presented, e.g., on a display, to a user, e.g., to an operator or a TMC. In some applications, a definition of a region of interest (ROI) may be obtained from the user, and location of the detected hazard lights that are within the region of interest may be presented to the user. It is noted that embodiments of the invention may detect hazard lights that originate from sources, e.g., vehicles, that are located within the analyzed frames or within the ROI, as well as hazard lights that originate from sources, e.g., vehicles, that are located outside of the analyzed frames or outside of the ROI, e.g., by detecting the reflection of the hazard light on other objects that are included within the analyzed frames or within the ROI.

Some of road cameras 180 and 182 may include independent and un-cooperative PTZ movements, e.g., the camera may change at least one of its pan, tilt and zoom independently from traffic control server 130. According to embodiments of the invention, such PTZ movements may be detected, e.g., by comparing consecutive images, and if a change in PTZ values of road camera 180 providing the video stream is detected, the ROI and the downsampling may be adjusted to the new PTZ values, e.g., the process of downsampling may be reset.

According to some embodiments, the hazard lights event may be fused or combined with other event sources and context such as in-car hazard light information, traffic metrics, weather, geography, and accident risk to prioritize the event and to generate enriched events and further improve accuracy of detection. For example, a confidence value of detecting hazard lights from a video stream may increase if an event of hazard lights or stopped vehicle is obtained from a connected vehicle in the same location.

In some embodiments, detecting hazard lights, e.g., detecting that hazard lights are blinking, may trigger an automatic action by system 100. For example, an emergency alarm may be issued, a notification may be sent to road safety personnel, e.g., including time and location of the detected hazard lights, safety devices may be triggered, lanes may be closed, e.g., by automatically activating road signs that indicate that a specific lane is closed, etc.

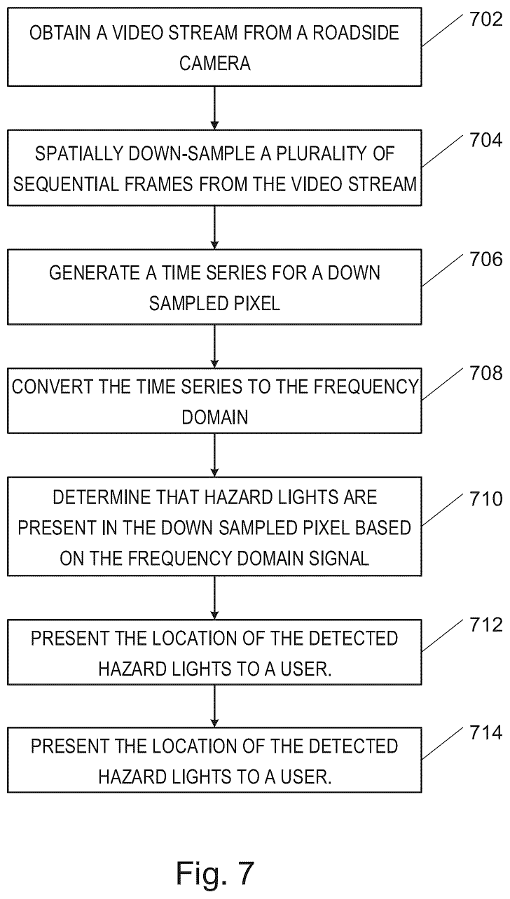

Reference is now made to FIG. 7, which is a flowchart of a method for detecting hazard lights of vehicles, according to embodiments of the invention. While in some embodiments the operations of FIG. 7 are carried out using systems as shown in FIGS. 1 and/or 8, in other embodiments other systems and equipment can be used.

In operation 702, a processor (e.g., processor 705 depicted in FIG. 8) may obtain or receive a video stream from a roadside camera (e.g., camera 180 or 182 in FIG. 1). In operation 704, the processor may spatially downsample a plurality of sequential frames from the video stream in any applicable manner. For example, the processor may convert the frame into grayscale image, divide the frame into smaller grid boxes, and calculate a measures of center, e.g., median, mean or mode, of the grayscale values in each grid box. Other methods may be used. In operation 706, the processor may generate a time series for a down-sampled pixel, e.g., by ordering the grayscale values at the down-sampled pixel over time. In operation 708, the processor may convert the time series to the frequency domain, e.g., using FFT or any other applicable method. In operation 710, the processor may determine that hazard lights are present in the down-sampled pixel based on the frequency domain representation, e.g., based on amplitude and/or phase of the frequency domain representation, e.g., by detecting patterns in the amplitude and/or phase of the frequency domain representation that are indicative of blinking hazard lights. For example, the processor may filter the frequency domain representation, e.g., using a band pass filter, and may detect peaks in an amplitude of the filtered signal, e.g., a peak may be detected if the amplitude is above threshold. The processor may determine that hazard lights exist in the video stream if a peak is detected and that no hazard lights exist in the video stream otherwise. Additionally, the processor may use phase data. For example, the processor may compare phase data of frequency domain representations of two down-sampled pixels that include hazard lights from the same frame to determine if the hazard lights in both pixels originate from the same source (e.g., the same vehicle) or not. For example, if the phase of the two frequency domain representations is aligned or is the same, it may be determined that both down-sampled pixels contain hazard lights from a single source, and if the phase of the two frequency domain representations is not aligned, it may be determined that both down-sampled pixels contain hazard lights from two different sources. The processor may further use heuristics of the frequency domain signal, e.g., changes in the frequency domain signal over time, to refine and adjust the determination of hazard lights. For example, if hazard lights are detected at a region (e.g., at one or more down-sampled pixels), these hazard lights have to stay positive for some time (for example, 5, 10, 20 seconds) to be considered a true detection of hazard lights. In operation 712, the processor may present the location of the detected hazard lights to a user (e.g., via output device 740 of FIG. 8). In some embodiments, the processor may obtain an ROI from a user, and may analyse the ROI and present detected hazard lights that are within the ROI. The processor may further fuse or combine the detected hazard combined with other event sources and context such as in-car hazard light information, traffic metrics, weather, geography, and accident risk to prioritize the event and to further improve accuracy, and present the fused events to the user (e.g., via output device 740 of FIG. 8). In operation 714, the processor may automatically perform an action in response to detecting hazard lights, e.g., in response to detecting that hazard lights are blinking, e.g., the processor may issue an emergency alarm, send a notification to road safety personnel including time and location of the detected hazard lights, trigger safety devices, lane closures, etc.

Reference is made to FIG. 8, showing a high-level block diagram of an exemplary computing device according to some embodiments of the invention. Computing device 700 may include a processor 705 that may be, for example, a central processing unit processor (CPU) or any other suitable multi-purpose or specific processors or controllers, a chip or any suitable computing or computational device, an operating system 715, a memory 120, executable code 725, a storage system 730, input devices 735 and output devices 740. Processor 705 (or one or more controllers or processors, possibly across multiple units or devices) may be configured to carry out methods described herein, and/or to execute or act as the various modules, units, etc. for example when executing code 725. More than one computing device 700 may be included in, and one or more computing devices 700 may be, or act as the components of, a system according to embodiments of the invention. Various components, computers, and modules of FIG. 1 may include devices such as computing device 700, and one or more devices such as computing device 700 may carry out functions such as those described in FIG. 7. For example, traffic control server 130 may be implemented on or executed by a computing device 700.

Operating system 715 may be or may include any code segment (e.g., one similar to executable code 725) designed and/or configured to perform tasks involving coordination, scheduling, arbitration, controlling or otherwise managing operation of computing device 700, for example, scheduling execution of software programs or enabling software programs or other modules or units to communicate.

Memory 720 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short-term memory unit, a long term memory unit, or other suitable memory or storage units. Memory 720 may be or may include a plurality of, possibly different memory units. Memory 720 may be a computer or processor non-transitory readable medium, or a computer non-transitory storage medium, e.g., a RAM. Memory 720 may be or may include a non-transitory computer-readable storage medium storing instructions, which when executed by a processor or controller, carry out methods disclosed herein.

Executable code 725 may be any executable code, e.g., an application, a program, a process, task or script. Executable code 725 may be executed by processor 705 possibly under control of operating system 715. For example, executable code 725 may configure processor 705 to detect hazard lights in video streams, and perform other methods as described herein. Although, for the sake of clarity, a single item of executable code 725 is shown in FIG. 8, a system according to some embodiments of the invention may include a plurality of executable code segments similar to executable code 725 that may be loaded into memory 720 and cause processor 705 to carry out methods described herein.

Storage system 730 may be or may include, for example, a hard disk drive, a CD-Recordable (CD-R) drive, a Blu-ray disk (BD), a universal serial bus (USB) device or other suitable removable and/or fixed storage unit. Data such as the measured velocities as well as other data required for performing embodiments of the invention, may be stored in storage system 730 and may be loaded from storage system 730 into memory 720 where it may be processed by processor 705. Some of the components shown in FIG. 8 may be omitted. For example, memory 720 may be a non-volatile memory having the storage capacity of storage system 730. Accordingly, although shown as a separate component, storage system 730 may be embedded or included in memory 720.

Input devices 735 may be or may include a mouse, a keyboard, a microphone, a touch screen or pad or any suitable input device. Any suitable number of input devices may be operatively connected to computing device 700 as shown by block 735. Output devices 740 may include one or more displays or monitors, speakers and/or any other suitable output devices. Any suitable number of output devices may be operatively connected to computing device 700 as shown by block 740. Any applicable input/output (I/O) devices may be connected to computing device 700 as shown by blocks 735 and 740. For example, a wired or wireless network interface card (NIC), a printer, a universal serial bus (USB) device or external hard drive may be included in input devices 735 and/or output devices 740.

In some embodiments, device 700 may include or may be, for example, a personal computer, a desktop computer, a laptop computer, a workstation, a server computer, a network device, a smartphone or any other suitable computing device. A system as described herein may include one or more devices such as computing device 700. Device 700 or parts thereof may be implemented in a remote location, e.g., in a ‘cloud’computing system.

When discussed herein, “a” computer processor performing functions may mean one computer processor performing the functions or multiple computer processors or modules performing the functions; for example, a process as described herein may be performed by one or more processors, possibly in different locations.

In the description and claims of the present application, each of the verbs, “comprise”, “include” and “have”, and conjugates thereof, are used to indicate that the object or objects of the verb are not necessarily a complete listing of components, elements or parts of the subject or subjects of the verb. Unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of an embodiment as described. In addition, the word “or” is considered to be the inclusive “or” rather than the exclusive or, and indicates at least one of, or any combination of items it conjoins.

Descriptions of embodiments of the invention in the present application are provided by way of example and are not intended to limit the scope of the invention. The described embodiments comprise different features, not all of which are required in all embodiments. Embodiments comprising different combinations of features noted in the described embodiments, will occur to a person having ordinary skill in the art. Some elements described with respect to one embodiment may be combined with features or elements described with respect to other embodiments. The scope of the invention is limited only by the claims.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

1. A method for detecting hazard lights of vehicles in a video stream, the method comprising:
spatially downsampling a plurality of sequential frames from the video stream to obtain a plurality of down-sampled pixels in each of the frames; and
repeating for one or more of the plurality of down-sampled pixels:
generating a time series for the down-sampled pixel by ordering values of the down-sampled pixel from the plurality of sequential frames over time;
converting the time series into the frequency domain to obtain a frequency domain representation of the time series; and
determining that hazard lights are present in the down-sampled pixel based on the frequency domain representation.

2. The method of claim 1, wherein determining that the hazard lights are present in the down-sampled pixel comprises applying a band pass filter to the frequency domain representation to obtain a filtered signal.

3. The method of claim 2, wherein determining that the hazard lights are present in the down-sampled pixel comprises:
detecting peaks in an amplitude of the filtered signal; and
detecting the hazard lights if a detected peak satisfies a threshold.

4. The method of claim 3, comprising:
comparing a phase of the filtered signal with a phase of a filtered signal of a neighbour down-sampled pixel; and
determining that the filtered signal and the filtered signal of a neighbour down-sampled pixel originate from a single source if the phase of the filtered signal equals the phase of the filtered signal of a neighbour down-sampled pixel and that the filtered signal and the filtered signal of a neighbour down-sampled pixel originate from two sources.

5. The method of claim 1, wherein determining that the hazard lights are present in the down-sampled pixel is performed further based on heuristics of the frequency domain signal.

6. The method of claim 1, comprising converting the frame into grayscale.

7. The method of claim 6, wherein spatially downsampling a frame of the plurality of sequential frames comprises:
dividing the frame into smaller grid boxes; and
calculating a measures of center of the grayscale values in each grid box.

8. The method of claim 1, comprising:
presenting the location of the detected hazard lights to a user.

9. The method of claim 1, comprising:
obtaining a definition of a region of interest from a user; and
presenting the location of the detected hazard lights that are within the region of interest to the user.

10. The method of claim 9, comprising:
detecting a change in pan, tilt and zoom (PTZ) values of a camera providing the video stream; and
adjusting the region of interest and the downsampling to the new PTZ values.

11. The method of claim 1, comprising:
unifying the hazard lights event with other event sources and context such as in-car hazard light information, traffic metrics, weather, geography, and accident risk to prioritise the event.

12. A system for detecting hazard lights of vehicles in a video stream, the system comprising:
a memory; and
a processor configured to:
spatially downsample a plurality of sequential frames from the video stream to obtain a plurality of down-sampled pixels in each of the frames; and
repeat for one or more of the plurality of down-sampled pixels:
generate a time series for the down-sampled pixel by ordering values of the down-sampled pixel from the plurality of sequential frames over time;
convert the time series into the frequency domain to obtain a frequency domain representation of the time series; and
determine that hazard lights are present in the down-sampled pixel based on the frequency domain representation.

13. The system of claim 12, wherein determining that the hazard lights are present in the down-sampled pixel comprises applying a band pass filter to the frequency domain representation to obtain a filtered signal.

14. The system of claim 13, wherein determining that the hazard lights are present in the down-sampled pixel comprises:
detecting peaks in an amplitude of the filtered signal; and
detecting the hazard lights if a detected peak satisfies a threshold.

15. The system of claim 12, comprising:
comparing a phase of the filtered signal with a phase of a filtered signal of a neighbour down-sampled pixel; and
determining that the filtered signal and the filtered signal of a neighbour down-sampled pixel originate from a single source if the phase of the filtered signal equals the phase of the filtered signal of a neighbour down-sampled pixel and that the filtered signal and the filtered signal of a neighbour down-sampled pixel originate from two sources.

16. The system of claim 12, wherein determining that the hazard lights are present in the down-sampled pixel is performed further based on heuristics of the frequency domain signal.

17. The system of claim 12, comprising converting the frame into grayscale.

18. The system of claim 17, wherein spatially downsampling a frame of the plurality of sequential frames comprises:
dividing the frame into smaller grid boxes; and
calculating a measures of center of the grayscale values in each grid box.

19. The system of claim 12, comprising:
presenting the location of the detected hazard lights to a user.

20. The system of claim 12, comprising:
obtaining a definition of a region of interest from a user; and
presenting the location of the detected hazard lights that are within the region of interest to the user.

21. The system of claim 20, comprising:
detecting a change in pan, tilt and zoom (PTZ) values of a camera providing the video stream; and
adjusting the region of interest and the downsampling to the new PTZ values.

22. The system of claim 20, comprising:
unifying the hazard lights event with other event sources and context such as in-car hazard light information, traffic metrics, weather, geography, and accident risk to prioritise the event.
